(19) United States
(12) Patent Application Publication
(10) Pub. No.: US 2013/0307655 A1
(43) Pub. Date: Nov. 21, 2013

(54) Surface Mount Inductor and Method for Producing Surface Mount Inductor

(71) Applicants: Koichi Saito, Tsurugashima-shi (JP); Chitoshi Sakai, Tsurugashima-shi (JP)

(72) Inventors: Koichi Saito, Tsurugashima-shi (JP); Chitoshi Sakai, Tsurugashima-shi (JP)

(21) Appl. No.: 13/982,990

(22) PCT Filed: Jan. 30, 2012
(86) PCT No.: PCT/JP2012/051976

§ 371 Date: Jul. 31, 2013

(30) Foreign Application Priority Data
Jan. 31, 2011 (JP) 2011-017581

(51) Int. Cl. H01F 27/02; H01F 41/00

(52) U.S. Cl. CPC H01F 27/022; H01F 41/005
USPC 336/83; 29/605

(57) ABSTRACT

A surface-mount inductor according to this invention comprises a coil formed by winding a rectangular conductive wire in an outward spiral pattern (so that opposite ends of the conductive wire become outermost periphery), a core made primarily of magnetic powders and binder, and an external electrode formed on one surface of the core. Further, the surface-mount inductor is characterized by encapsulating the coil in the core so that winding axis of the coil is parallel to the surface of the core on which the external electrode is formed.

### TECHNICAL FIELD

The present invention relates to a downsized surface-mount inductor and a method of producing the same.

### BACKGROUND

A surface-mount inductor is widely used which has a structure where a coil formed by winding a wire rod is encapsulated in a core. With the recent downsizing or thinning of electronic devices such as mobile phone, electronic components such as surface-mount inductor are also required to be downsized and lowered. Accordingly, the Applicant has proposed, in the previously filed JP2010-245473, a downsized surface-mount inductor with a coil and a preformed tablet, wherein the coil is formed by winding a rectangular conductive wire in an outward spiral pattern to allow opposite ends of the conductive wire to be led out to the periphery, and a method of producing such a surface-mount inductor.

### SUMMARY

### Object to be Accomplished by the Invention

According to the surface-mount inductor of JP2010-245473, a coil formed by winding a rectangular conductive wire in an outward spiral pattern to allow opposite ends of the conductive wire to be led out to the periphery is placed on a tablet and is set in a molding die, which is subjected to compression molding at or above a temperature of softening point of the tablet to obtain a formed body. From opposite lateral sides of the formed body, an external electrode is formed using a technique such as dipping. As a result, an external electrode 103 is formed over five surfaces of a formed body 102, as shown in FIG. 10. Therefore, it has been a common practice for the conventional surface-mount inductor to form the external electrode even on a top surface of the core. However, with further downsizing of electronic devices, the surface-mount inductor having such a structure is likely to cause short-circuit due to a contact of the external electrode formed on the top surface with a shield plate. For this reason, there has been increased demand for a surface-mount inductor having a bottom electrode structure.

Heretofore, a surface-mount inductor having a bottom electrode structure is disclosed in documents such as JP2009-290076. According to the surface-mount inductor having a bottom electrode structure disclosed in JP2009-290076, a coil 201 is formed by winding a wire rod as shown in FIG. 11, and a magnetic body 202 is formed having a structure where two lead terminals 201a of the coil 201 are externally protruded from a first surface (electrode-forming surface). In this case, the coil 201 is encapsulated to allow its winding axis to be orthogonal to the electrode-forming surface. Thereafter, an external electrode 203 is formed on a predetermined position of the electrode-forming surface to produce a surface-mount inductor having a bottom electrode structure. In the case of this structure, the right-and-left positional relationship between the internal structure of the coil and the external electrode is asymmetric because the coil is positioned to allow its winding axis to be orthogonal to the electrode-forming surface. This means that if the inductor is mounted with its right and left being replaced with each other when it is mounted on a circuit board, the start and end positions of winding of the coil are inverted. If the start and end positions of winding of the coil are inverted, the direction of magnetic flux generated is also inverted, which would have an influence on neighboring components.

It is an object of the present invention to provide a downsized surface-mount inductor having a bottom electrode structure which generates a constant direction of magnetic flux even if it is mounted with its right and left being replaced with each other. In addition, it is an object of the present invention to provide a method of producing such a surface-mount inductor.

### Means to Accomplish the Object

In order to achieve this object, the present invention provides a surface-mount inductor comprising a coil formed by winding a rectangular conductive wire in an outward spiral pattern (to allow both ends of the conductive wire to be outermost periphery), a core made primarily of magnetic powders and binder, and an external electrode formed on one surface of the core. Further, the surface-mount inductor is characterized by encapsulating the coil in the core to allow a winding axis of the coil to be parallel to the surface of the core on which the external electrode is formed.

### Effect of the Invention

The surface-mount inductor according to this invention has an advantage in terms of characteristics such as L-value, DC resistance and DC superimposition characteristics because the areas of core and winding can be enlarged by an amount corresponding to the thickness of the electrode other than those on the mounting surface as compared to conventional surface-mount inductors. Alternatively, it can be downsized or lowered by an amount corresponding to the thickness of the electrode. Further, this surface-mount inductor has an advantage in terms of circuit efficiency in that eddy current caused by leakage flux is hard to be generated because its electrode area is smaller as compared to conventional surface-mount inductors.

The positional relationship between the internal coil structure and the external electrode is symmetric because an coil wound in an outward spiral pattern is encapsulated in a core to allow its winding axis to be parallel to the electrode-forming surface. This means that the winding direction of the coil would be the same either on right or left of the inductor with respect to a circuit board. As a result, the surface-mount inductor of this invention has a constant direction of magnetic flux generated even if it is mounted on a circuit board with its right and left being replaced with each other, and thus it is not necessary to take the directivity of the surface-mount inductor into account when it is mounted.

### BRIEF DESCRIPTION OF DRAWINGS

FIG. 1 is a perspective view of an air-cored coil for use in a surface-mount inductor according to a first embodiment of this invention.

FIG. 2 is a perspective view of a preformed body of the surface-mount inductor according to the first embodiment of this invention.

FIG. 3 illustrates a process of producing the surface-mount inductor according to the first embodiment of this invention.

FIG. 4 is a transparent view showing an encapsulation structure of a coil of the surface-mount inductor according to the first embodiment of this invention.

FIG. 5 illustrates a process of producing the surface-mount inductor according to the first embodiment of this invention.

FIG. 6 is a perspective view of the surface-mount inductor according to the first embodiment of this invention.

FIG. 7 is a perspective view of an air-cored coil for use in a surface-mount inductor according to a second embodiment of this invention.

FIG. 8 illustrates a process of producing the surface-mount inductor according to the second embodiment of this invention.

FIG. 9 is a perspective view of the surface-mount inductor according to the second embodiment of this invention.

FIG. 10 is a perspective view illustrating a conventional surface-mount inductor.

FIG. 11 is a perspective view illustrating a conventional surface-mount inductor having a bottom electrode structure.

### FIRST EMBODIMENT

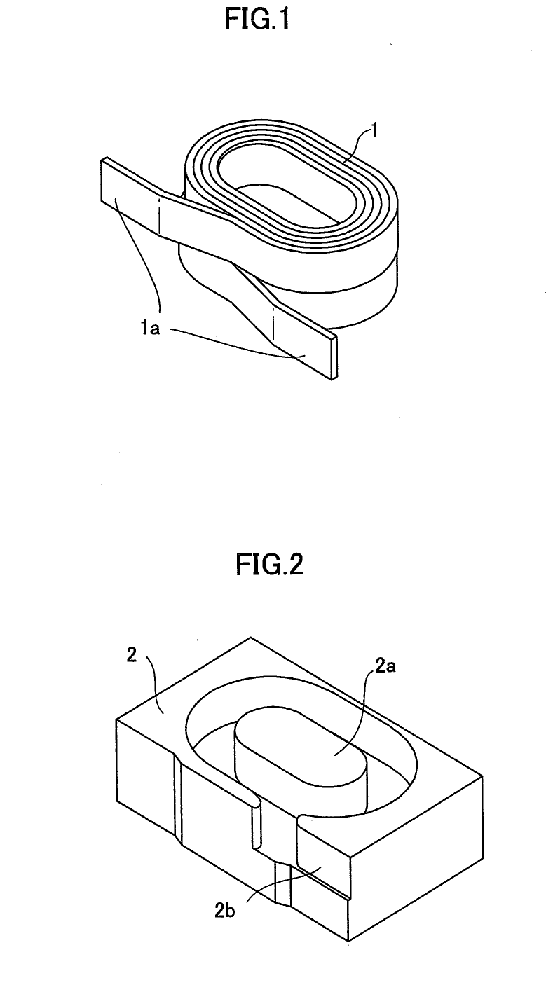

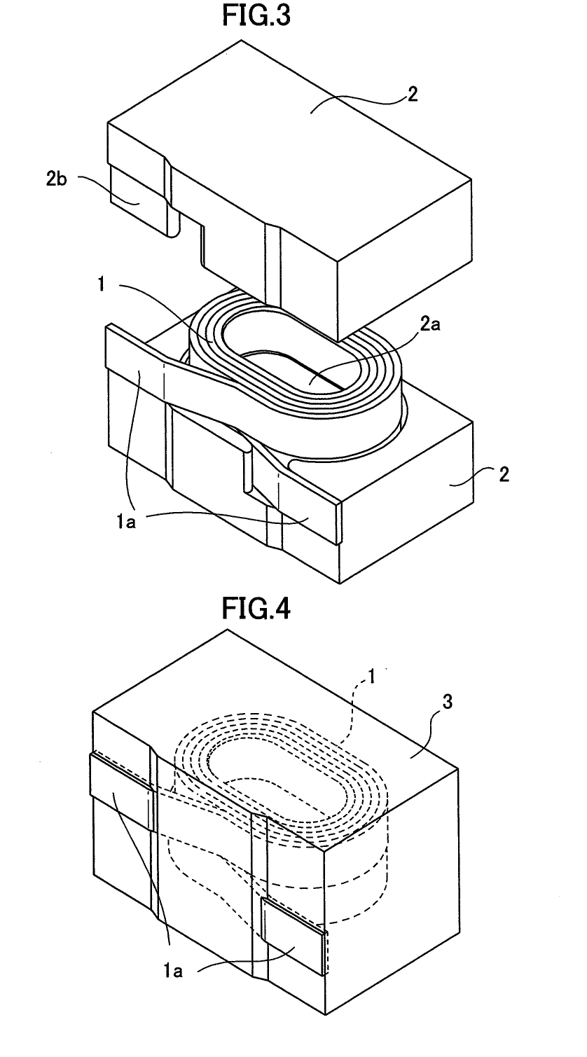

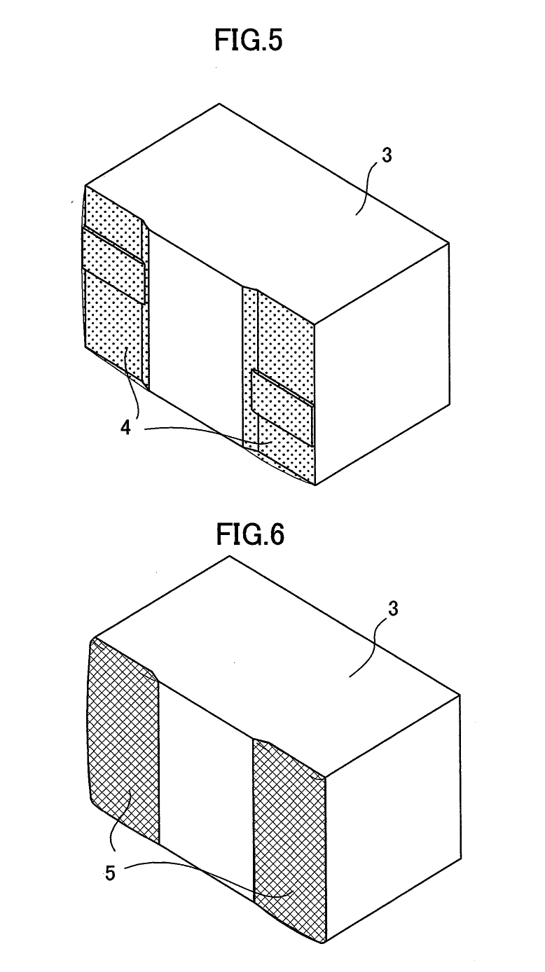

With reference to FIGS. 1 to 6, a surface-mount inductor according to a first embodiment of this invention will be described. FIG. 1 illustrates a perspective view of an air-cored coil for use in a surface-mount inductor according to the first embodiment of this invention. FIG. 2 illustrates a perspective view of a preformed body of the surface-mount inductor according to the first embodiment of this invention. FIGS. 3 and 5 illustrate processes of producing the surface-mount inductor according to the first embodiment of this invention. FIG. 4 illustrates an encapsulation structure of a coil of the surface-mount inductor according to the first embodiment of this invention. FIG. 6 illustrates a perspective view of the surface-mount inductor according to the first embodiment of this invention.

Initially, as shown in FIG. 1, an air-cored coil 1 is obtained by using a winding core having an oval shaped cross-section to wind a rectangular conductive wire having self-fusing coating in two-tiered outward spiral pattern. In this case, the air-cored coil 1 is formed to allow each of opposite ends 1a to be led out to the same lateral side.

Then, an encapsulation material obtained by mixing iron-based metal magnetic powders and epoxy resin is preformed to form a preformed body 2 comprising a convex portion 2a and a guide portion 2b as shown in FIG. 2. As shown in FIG. 3, the air-cored coil 1 is placed on the preformed body 2 such that the convex portion 2a of the preformed body 2 fits in a hollow portion of the air-cored coil. Over this, another preformed body 2 is covered. At this time, the ends 1a of the air-cored coil 1 are led out along the guide portion 2b of the preformed body 2. This is set in a cavity of a molding die in this condition and is subjected to compression molding at 150° C. to obtain a core 3 as shown in FIG. 4. As shown in FIG. 4, the air-cored coil 1 is encapsulated in the core 3 to allow opposite ends 1a of the coil 1 to be exposed on a surface of the core 3 which is parallel to the winding axis of the air-cored coil 1. The surface on which the opposite ends 1a are exposed becomes an electrode-forming surface of the core 3 (bottom surface of the surface-mount inductor).

Then, as shown in FIG. 5, after deburring and removing the coating on surfaces of exposed opposite ends 1a by sandblasting, conductive paste 4 is transfer-coated and cured on the electrode-forming surface of the core 3. This brings the conductive paste 4 and the internal air-cored coil 1 into conduction state. Finally, plate processing is conducted to form an external electrode 5 on a surface of the conductive paste 4 to obtain a surface-mount inductor as shown in FIG. 6. It should be noted that the electrode formed by the plate processing may be formed by appropriately selecting one or more materials from Ni, Sn, Cu, Au, Pd, and the like.

### SECOND EMBODIMENT

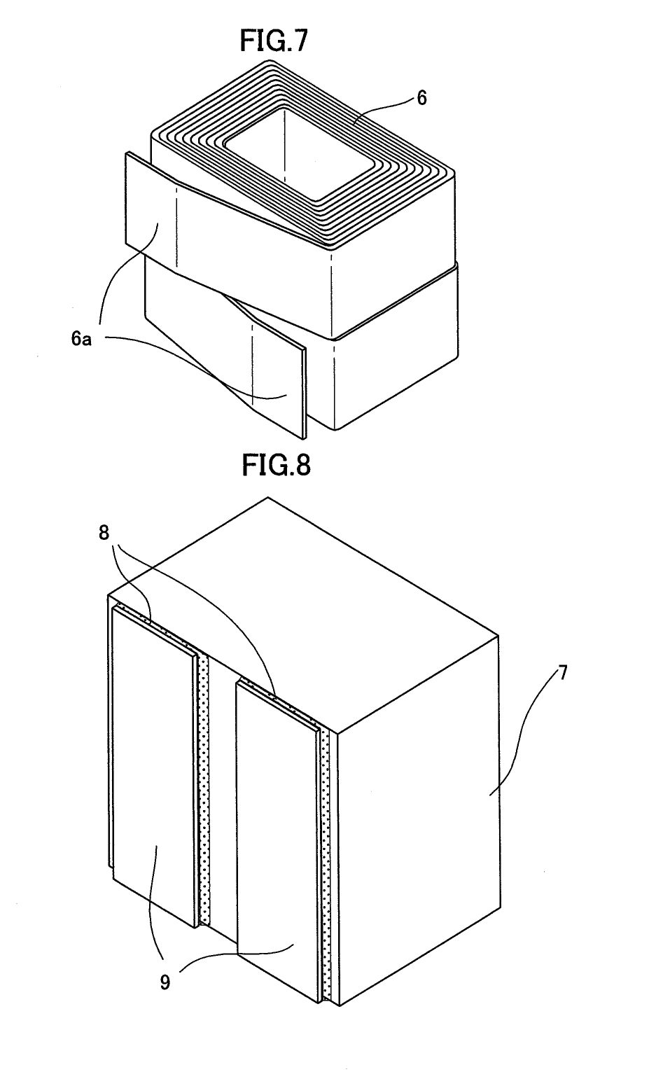

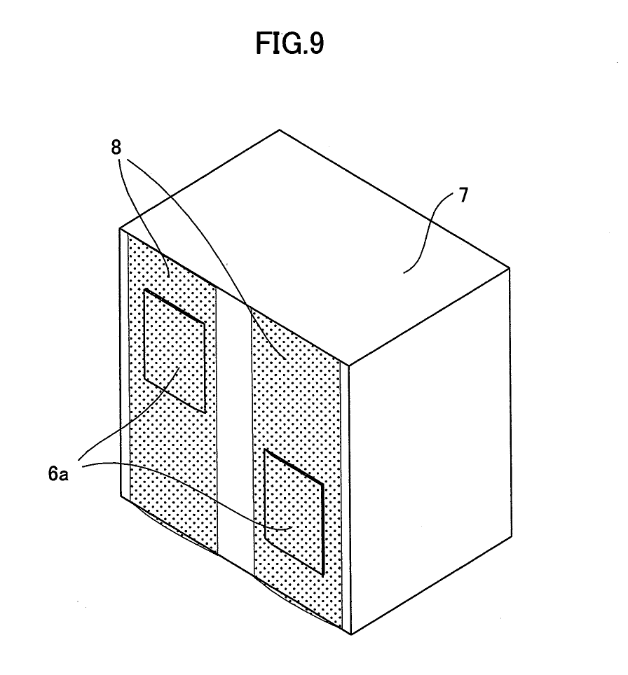

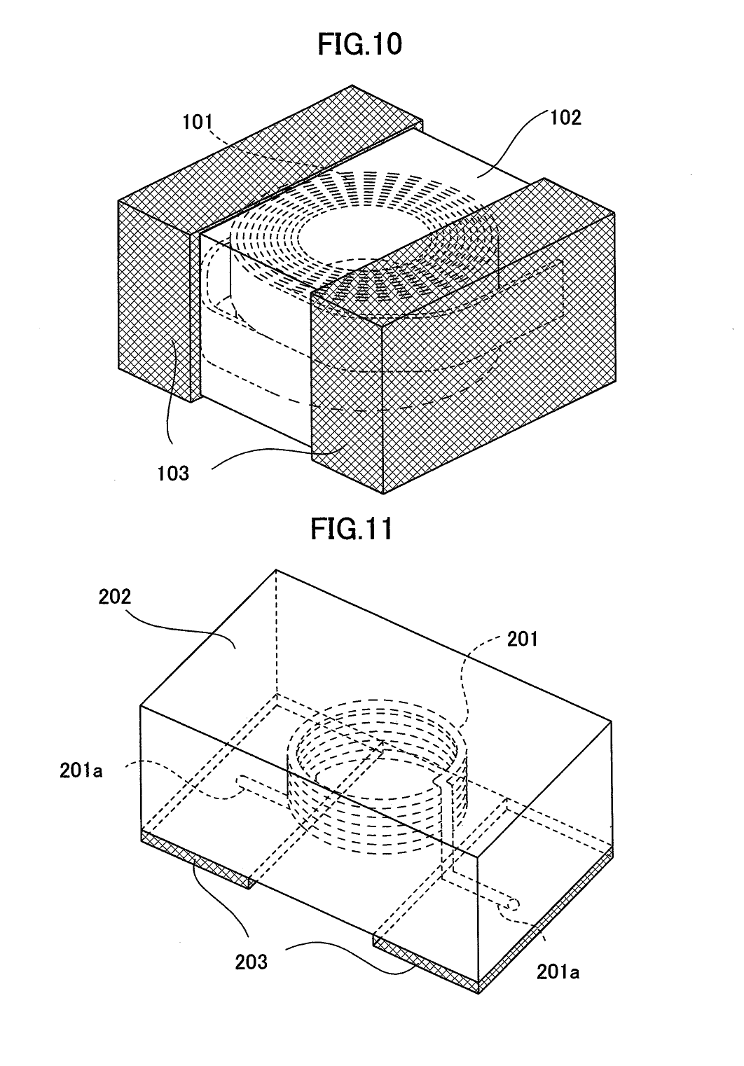

With reference to FIGS. 7 to 9, a surface-mount inductor according to a second embodiment of this invention will be described. FIG. 7 illustrates a perspective view of an air-cored coil for use in a surface-mount inductor according to the second embodiment of this invention. FIG. 8 illustrates a process of producing the surface-mount inductor according to the second embodiment of this invention. FIG. 9 illustrates a perspective view of the surface-mount inductor according to the second embodiment of this invention. It is noted that the description of the parts overlapped with the first embodiment will be omitted.

Initially, as shown in FIG. 7, an air-cored coil 6 is obtained by using an square column shaped winding core to wind a rectangular conductive wire having self-fusing coating with insulation coating in two-tiered outward spiral pattern. In this case, the opposite ends 6a of the air-cored coil 6 are led out to the same lateral side.

Then, this is subjected to compression molding in a similar manner to the first embodiment to obtain a core 7 in which the air-cored coil 6 is encapsulated. In this case, the opposite ends 6a are exposed on a surface of the core 7 which is parallel to the winding axis of the air-cored coil 6. The surface on which the opposite ends 6a are exposed becomes an electrode-forming surface of the core 7. Sandblasting is performed to deburr and remove the coating on surfaces of exposed opposite ends 6a, and conductive paste 8 is transfer-coated on the electrode-forming surface as shown in FIG. 8 to bring it into conduction state with the internal air-cored coil 6.

Then, an external electrode 9 made from a metal frame is attached by means of the conductive paste 8, and the conductive paste 8 is cured to obtain a surface-mount inductor as shown in FIG. 9.

In the above embodiments, an iron-based metal magnetic powder and an epoxy resin are used as the magnetic powders and the binder of the encapsulation material, respectively. The use of the iron-based metal magnetic powder makes it possible to produce a surface-mount inductor excellent in DC superposition characteristic. Alternatively, magnetic powders for use in the encapsulation material may be, for example, ferritic magnetic powders or magnetic powders that are subjected to surface modification such as formation of insulation coating or surface oxidation. In addition, inorganic materials such as glass powders may be added. Further, the binder for use in the encapsulation material may be other thermosetting resin such as a polyimide resin or a phenol resin, or may be a thermoplastic resins such as a polyethylene resin or a polyamide resin, or may be an inorganic binder.

In the above embodiments, an oval and a rectangular shapes of air-cored coils wound in an outward spiral pattern are prepared. Alternatively, the air-cored coil wound in an outward spiral pattern may have any shape excluding a curve of constant width, e.g., an elliptic or fan-like, semicircular, trapezoidal or polygonal shape, or combination thereof. These shapes prevent the rotation of air-cored coil when it is formed. Further, these shapes provide a structural stability in the prepared surface-mount inductor when it is mounted and realize the lowering thereof. In addition, the coil may have a magnetic core instead of the air-core.

In the above embodiments, the core is prepared using compression molding technique that is one of plastic molding techniques. Alternatively, the core may be prepared using, for example, molding techniques such as compacting molding technique. With respect to the dimensions of the core, the height dimension (direction from an electrode-forming surface to the surface opposing thereto) formed to be equal to or less than the length or width dimension provides good stability when the core is mounted.

In the above embodiments, transfer method is used as a method of applying a conductive paste. Alternatively it is also possible to use a method such as an application by dispenser or a dipping method. Further, in the above embodiments, sandblasting is used as a method of stripping the coating on the surface of the ends of the coil. Alternatively, it is also possible to use a method such as mechanical stripping. In addition, the coating on the end portion may be stripped in advance prior to the formation of the core.

1. A surface-mount inductor comprising:
a coil formed by winding a conductive wire having a rectangular cross-section;
a core made primarily of magnetic powders and binder; and
an external electrode formed on one surface of the core,
wherein both ends of the conductive wire of the coil become outermost periphery of the coil, and the coil is encapsulated in the core to allow a winding axis of the coil to be parallel to the surface of the core on which the external electrode is formed.

2. The surface-mount inductor as defined in claim 1, wherein the coil has any shape excluding a curve of constant width.

3. The surface-mount inductor as defined in claim 2, wherein the coil has a shape selected from the group consisting of oval, elliptical, and rectangular.

4. A method of producing a surface-mount inductor, comprising the steps of:
preparing a coil by winding a rectangular conductive wire in an outward spiral pattern;
forming a core by encapsulating the coil with an encapsulation material consisting mainly of magnetic powders and binder, wherein the encapsulation is performed to allow both ends of the coil to be exposed on one surface of the core and a winding axis of the coil to be parallel to the surface on which the ends are exposed; and
forming an external electrode on the surface of the core on which the ends are exposed.

5. The method of producing a surface-mount inductor as defined in claim 4, wherein the step of forming the core comprises the sub-steps of:
forming a preformed body using the encapsulation material; and
integrating the preformed body with the coil by compression molding.
